(19) United States
(12) Patent Application Publication
(10) Pub. No.: US 2009/0009427 A1
(43) Pub. Date: Jan. 8, 2009

(54) Head-Mount Display

(75) Inventors: Nobuyuki Miyake, Hiratuka-shi (JP); Satoshi Ejima, Tokyo (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/224,375

(22) PCT Filed: Mar. 14, 2007
(86) PCT No.: PCT/JP2007/055052

§ 371 Date: Aug. 26, 2008

(30) Foreign Application Priority Data
Mar. 15, 2006 (JP) 2006-071023

(51) Int. Cl. G09G 5/00

(52) U.S. Cl. 345/8

(57) ABSTRACT

Switches and the like 6 that are used to control video images displayed on the display part 5 are installed on the headphone 1 for the left ear to which no display arm holding part 3 or display arm 4 is attached. The user operates these switches and the like 6 with the left hand. Since these switches and the like 6 are attached to the headphone 1 for the left ear, which is on the side opposite from the headphone 1 for the right ear to which the display arm holding part 3 and display arm 4 are attached, there is no touching of the display arm holding part 3 or display arm 4 by hand during the operation, thus reducing the possibility of the position of the display part 5 being altered.

### TECHNICAL FIELD

The present invention relates to a head-mounted display.

### BACKGROUND ART

In recent years, various ocular type video display devices have been proposed in which video images displayed on a display such as a liquid crystal panel (LCD) are observed as false images that are enlarged via an optical system having an ocular lens, half-mirror, or the like; such display devices are called “head-mounted displays.” An example of such head-mounted displays is described, for instance, in WO 2004/061519A1 (Patent Document 1).

In most cases, such video display devices are constructed so as to be mounted on the face in a form that is wrapped around the head. Such devices include devices of the both-eye type in which video display systems are formed in positions corresponding to both eyes, and devices of the one-eye type in which a video display system is formed in a position corresponding to one eye (left or right eye).

Conventional head-mounted displays for one-eye use include an example in which two headphones are linked by a linking part, a display arm is attached to one of these headphones, and a display part is provided at the tip end part of the display arm. In general, switches and the like that operate the video image and audio of such head-mounted displays are often separated from the main body part of the head-mounted display mounted on the head.

In such cases, however, wiring is required between the head-mounted display main body part and a box that accommodates the switches and the like, so that the following problems are encountered: namely, in addition to the device becoming complicated, if this wiring is pulled, the posture of the head-mounted display main body part is altered, so that the display part is shifted from the observing position, making the video images hard to see.

Meanwhile, Published Japanese translation of a PCT application H9-504102 (Patent Document 2) describes an example in which some operating switches and the like are provided on the side of the headphone part to which the display arm is attached.

### [Patent Document 1] WO 2004/061519A1

[Patent Document 1] Published Japanese translation of a PCT application H9-504102

### DISCLOSURE OF THE INVENTION

### Problems to be Solved by the Invention

However, if operating switches and the like are installed on the side of the headphone part to which the display arm is attached, the following problem is encountered: namely, the user touches the display arm when operating these operating switches; as a result, the position of the display part is shifted.

The present invention was devised in light of such circumstances, and it is an object of the present invention to provide a head-mounted display that does not cause the position of the display part to be shifted easily during the operation of the switches and the like.

### Means for Solving the Problems

The first means used to achieve the object described above is a head-mounted display comprising two headphones, a linking part that links the two headphones, a display arm which is held on one of the headphones and whose tip end part is made parallel to the face during use, and a display part which is attached to the tip end part of the display arm and which displays video images to the eye of the user, wherein switches and the like that operate video images displayed on the display part are installed on the linking part on the side opposite from the headphone to which the display arm is attached, or on the headphone on the side opposite from the headphone to which the display arm is attached.

In this means, switches and the like that operate video images displayed on the display part are installed on the linking part on the side opposite from the headphone to which the display arm is attached, or on the headphone on the side opposite from the headphone to which the display arm is attached. Therefore, the user does not touch the display arm while operating these switches and the like, and [the user] also does not touch the headphone part to which the display arm is attached. Consequently, the position of the display part is less likely to be shifted during the operation of the switches and the like.

The second means used to solve the problem described above is a head-mounted display comprising one headphone, a mounting part which holds the headphone on one side and causes this headphone to be mounted on the head of the user, a display arm which is held on the headphone and whose tip end part is made parallel to the face during use, and a display part which is attached to the tip end part of the display arm and which displays video images to the eye of the user, wherein switches and the like that operate video images displayed on the display part are installed on the mounting part on the side opposite from the headphone.

In this means, only one headphone is present, and the portion including this headphone is mounted on the head by the mounting part. Since switches and the like that operate video images displayed on the display part are installed on the mounting part on the side opposite from the headphone, when the user operates these switches and the like, there is no touching of the display arm, nor is there any touching of the headphone part to which the display arm is attached. Accordingly, the position of the display part is less likely to be shifted during the operation of the switches and the like.

The third means used to solve the problem described above is the second means, wherein the location where the switches and the like are installed is in the portion where the mounting part contacts the head of the user or in the vicinity of this portion.

In this means, since the switches and the like are installed in the portion where the mounting part contacts the head of the user or in the vicinity of this portion, the operation of the switches and the like is less likely to cause the mounting part to move. As a result, the shifting of the position of the display part is particularly less likely to occur during the operation of the switches and the like.

The fourth means used to solve the problem described above is any of the first through third means, wherein a power switch that does not concern the operation of the video images is installed on the side of the headphone to which the display arm is attached.

### EFFECT OF THE INVENTION

With the present invention, it is possible to provide a head-mounted display in which the position of the display part is not likely to be shifted during the operation of the switches and the like.

### BRIEF DESCRIPTION OF THE DRAWINGS

FIG. 1 is a schematic diagram showing a state in which a head-mounted display constituting a first working configuration of the present invention is mounted on the head.

FIG. 2 is a schematic diagram showing a state in which a head-mounted display constituting a second working configuration of the present invention is mounted on the head.

FIG. 3 is a diagram showing an example in which a power switch that performs the on/off switching of the power supply of a head-mounted display is provided on the lower side of the display arm holding part.

FIG. 4 is a diagram showing the state immediately after a head-mounted display is mounted on the head.

### EXPLANATION OF SYMBOLS

1 . . . . Headphones, 2 . . . Linking part, 3 . . . Display arm holding part, 4 . . . Display arm, 5 . . . Display part, 6 . . . Switches and the like, 7 . . . Mounting part, 8 . . . Cushion.

### BEST MODE FOR CARRYING OUT THE INVENTION

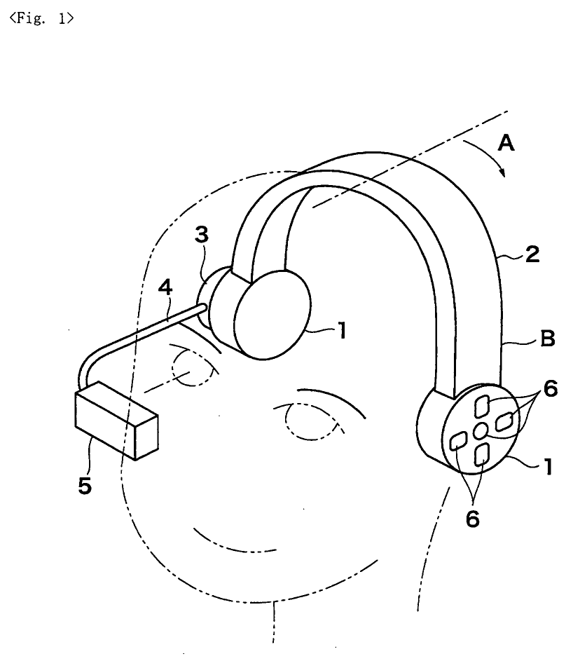

Working configurations of the present invention will be described below using the figures. FIG. 1 is a schematic diagram showing a state in which a head-mounted display constituting a first working configuration of the present invention is mounted on the head. Two headphones 1 are linked by a linking part 2. The linking part 2 has elasticity, and the head-mounted display is mounted in a configuration in which the ears are sandwiched between the headphones 1 from both sides by putting the linking part 2 on from the top of the head and placing the headphones 1 at the positions of the ears.

A display arm holding part 3 is provided on the headphone 1 for the right ear, and a display arm 4 is held on the display arm holding part 3 so as to be slidable in the forward-rearward [direction] of the head when [the head-mounted display] is mounted. Furthermore, the display arm holding part 3 is attached to this headphone 1 so as to be pivotable in the vertical direction when [the head-mounted display] is mounted. The tip end part of the display arm 4 is bent so as to be substantially parallel to the face when [the head-mounted display] is mounted, and a display part 5 that displays video images is attached to this tip end part.

When video images are to be viewed, the display part 5 is positioned in front of the eye in the state shown in FIG. 1, the distance between the display part 5 and the eye is adjusted by moving the display arm 4 forward and rearward, and the video images are observed. When [the head-mounted display is] used simply as headphones without observing video images, the display arm holding part 3 is caused to pivot around the headphone 1, and [this head-mounted display is] used in a state in which the display part 5 is positioned at the top of the head. If the display arm holding part 3 is caused to pivot further 180° around the headphone 1 from the state shown in FIG. 1, this head-mounted display can be used as the head-mounted display for the left eye.

Switches and the like 6 that are used to control the video images displayed on the display part 5 are provided on the headphone 1 for the left ear to which no display arm holding part 3 or display arm 4 is attached. The user operates these switches and the like 6 with the left hand. Since these switches and the like 6 are attached to the headphone 1 for the left ear located on the side opposite from the headphone 1 for the right ear, to which the display arm holding part 3 and display arm 4 are attached, there is no touching of the display arm holding part 3 or display arm 4 by hand during the operation, thus reducing the possibility of altering the position of the display part 5.

The attachment position of the switches and the like 6 may also be on the linking part 2 on the side opposite from the right-side headphone 1, i.e., in the portion indicated by A, which is located to the left side of the top of the head. Even if this is done, the operation of the switches and the like 6 is performed with the left hand, so that the possibility of the hand touching the display arm holding part 3 and display arm 4 is reduced. In cases where the switches and the like 6 are provided on the linking part 2, the installation in section B of the linking part 2 near the headphone, in particular, reduces the possibility of the entire head-mounted display being moved by the operation because [these switches and the like] are located in positions near the portion where the linking part 2 and the headphone are fastened together.

The buttons for the switches and the like 6 are disposed in symmetrical positions both bilaterally and vertically with respect to the geometrical center of these buttons. Accordingly, even in cases where the display arm holding part 3 is caused to pivot 180° around the headphone 1, changing [the head-mounted display] from right-eye usage to left-eye usage, for instance, the dispositions of the buttons for the switches and like 6 do not change, so that the erroneous operation of the switches and like by the user is reduced. In such cases, furthermore, it is desirable that the functions of the respective buttons be made reversible both between left and right and between top and bottom between a case of left-eye usage and a case of right-eye usage.

Among the switches and the like, the switches and the like that control only the audio may also be installed on the right-side headphone 1 or on the right half of the linking part 2. The reason for this is that in cases where the head-mounted display is used simply as headphones, the display part 5 is not used, so that even if the position [of the display part 5] is changed slightly, this does not create a problem.

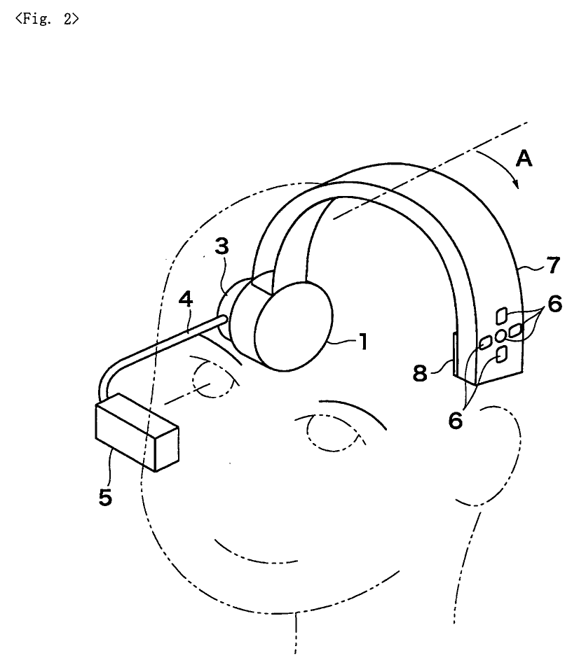

FIG. 2 is a schematic diagram showing a state in which a head-mounted display constituting a second working configuration of the present invention is mounted on the head. In FIG. 2, constituent elements that are the same as the constituent elements shown in FIG. 1 are labeled with the same symbols, and a description of these constituent elements may be omitted. In this working configuration, there is only one headphone 1, and this headphone 1 is attached to one end of a mounting part 7; a cushion 8 is provided at the other end of the mounting part 7 so as to contact the head. The mounting part 7 has elasticity, and when [the head-mounted display is] mounted on the head, this mounting is accomplished such that the head is sandwiched between the headphone 1 and the cushion 8. The display arm holding part 3, display arm 4, and display part 5 are the same as those shown in FIG. 1.

In this working configuration, the switches and the like 6 are installed in the vicinity of the cushion 8, which is the portion where the mounting part 7 contacts the head. The user operates these switches and the like 6 with the left hand. These switches and the like 6 are attached in the vicinity of the cushion 8 on the left side, which is on the side opposite from the headphone 1 for the right ear to which the display arm holding part 3 and display arm 4 are attached; accordingly, there is no touching of the display arm holding part 3 or display arm 4 by hand during the operation, thus reducing the possibility of the position of the display part 5 being altered.

The attachment position of the switches and the like 6 may be on the mounting part 7 on the side opposite from the headphone 1, i.e., in the portion indicated by A, which is located to the left side of the top of the head. Even if this is done, since the operation of the switches and the like 6 is performed with the left hand, the possibility of the hand touching the display arm holding part 3 and display arm 4 is reduced.

The buttons for the switches and the like 6 are disposed in symmetrical positions both bilaterally and vertically with respect to the geometrical center of these buttons. Accordingly, even in cases where the display arm holding part 3 is caused to pivot 180° around the headphone 1, changing [the head-mounted display] from right-eye usage to left-eye usage, for instance, the dispositions of the buttons for the switches and like 6 do not change, so that the erroneous operation of the switches and like by the user is reduced. In such cases, furthermore, it is desirable that the functions of the respective buttons be made reversible both between left and right and between top and bottom between a case of left-eye usage and a case of right-eye usage.

In such cases as well, among the switches and the like, switches and the like that control only the audio may also be installed on the headphone 1 or on the right half of the mounting part 7. The reason for this is that in cases where the head-mounted display is used simply as a headphone, the display part 5 is not used, so that even if the position [of the display part 5] is changed slightly, this does not create a problem.

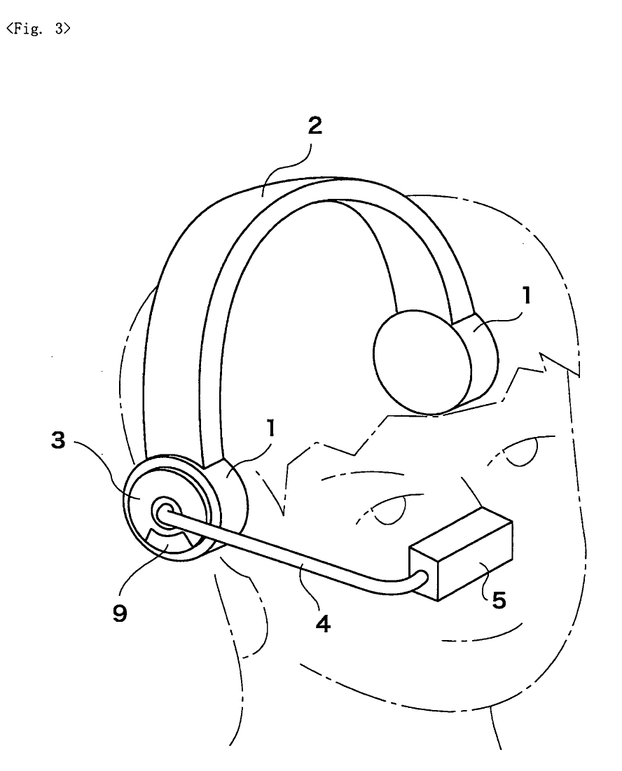

Furthermore, it would also be possible to install a power switch 9 that performs the on/off switching of the power supply of the head-mounted display on the lower side of the display arm holding part 3 as shown in FIG. 3. Here, the description involves a case of the working configuration shown in FIG. 1, but the same construction is also possible in the working configuration shown in FIG. 2.

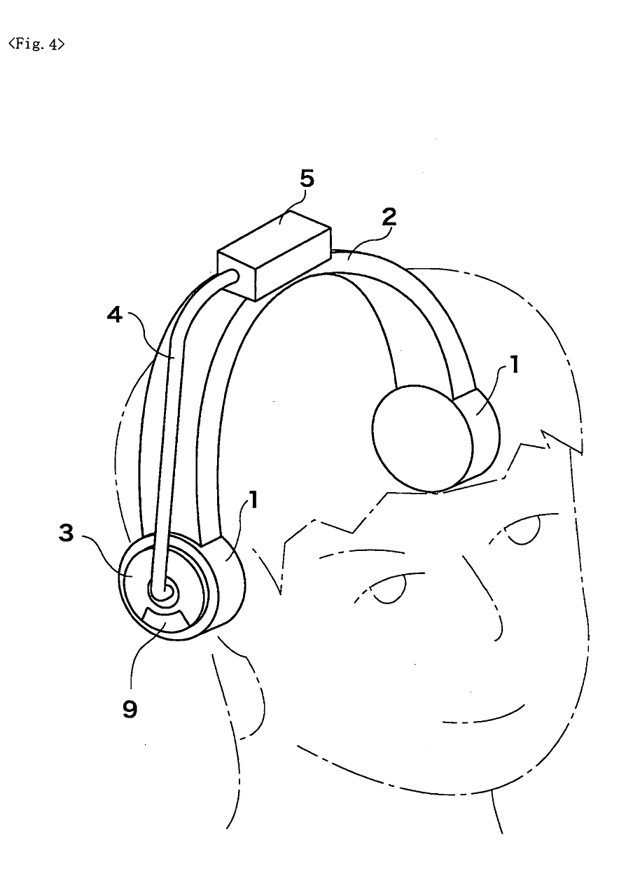

Moreover, FIG. 4 shows the appearance immediately after the user mounts a head-mounted display on the top of the head and immediately before the user removes this head-mounted display from the top of the head. Here, it is desirable that the display arm 4 be at the top of the head as shown in FIG. 4 before and after the attachment and removal of this device such that the display part 5 does not contact the eye of the user in the operation of attachment and removal actions.

Preferred actions following the mounting of the head-mounted display of the present invention on the head as shown in FIG. 4 are as follows: specifically, the power supply is turned on by operating the power switch 9, and the display arm 4 is then lowered to the front of the eye by pivoting this display arm 4 by hand. Here, since the power switch 9 and display arm 4 are provided on the display arm holding part on the right side, the series of actions described above are made possible using the right hand.

Furthermore, it would also be possible to design the device such that the content is automatically replayed upon passing of a specified period of time after the power is turned on (e.g., after five seconds), thus allowing the mounting of the device and the viewing and listening of the content to be performed solely by the right hand without the use of the switches and the like 6 by the left hand.

Moreover, when the use of the head-mounted display is over, the power switch 9 is turned off, and the display arm 4 is then caused to pivot to the top of the head by hand, thus placing the device in the state shown in FIG. 4. Here as well, the operation of the power switch 9 and the operation of the display arm 4 can be performed using the right hand, making the device easy to use.

Here, the power switch 9 is located in the display arm holding part 3, so that it is envisioned that the position of the device as a whole is shifted by the operation of the power switch 9. However, at the point when the power switch 9 is operated, either the display part 5 is not located in front of the eye, or even if the display part 5 is shifted, the position of the display part 5 can be corrected immediately by holding the display arm 4 with the right hand. Therefore, no problem occurs in terms of use.

Thus, with the present working configuration, the operating member that involves the on/off switching of the power supply is provided on the side of the headphone on which the display arm is installed. Accordingly, the series of actions involving the attachment of removal of the head-mounted display can be performed by one hand, thus forming a construction that is easy to use and convenient. Moreover, with regard to the actions after the power supply is switched on, since the operating member is provided on the headphone on the opposite side of the display arm, even if the operating member is operated while viewing images, there is no shifting of the display part 5, so that a construction is formed which is easy to use.

1. A head-mounted display comprising two headphones, a linking part that links the two headphones, a display arm which is held on one of the headphones and whose tip end part is made parallel to the face during use, and a display part which is attached to the tip end part of the display arm and which displays video images to the eye of the user, wherein switches and the like that operate video images displayed on the display part are installed on the linking part on the side opposite from the headphone to which the display arm is attached, or on the headphone on the side opposite from the headphone to which the display arm is attached.

2. A head-mounted display comprising one headphone, a mounting part which holds the headphone on one side and causes this headphone to be mounted on the head of the user, a display arm which is held on the headphone and whose tip end part is made parallel to the face during use, and a display part which is attached to the tip end part of the display arm and which displays video images to the eye of the user, wherein switches and the like that operate video images displayed on the display part are installed on the mounting part on the side opposite from the headphone.

3. The head-mounted display according to claim 2, wherein the location where the switches and the like are installed is in the portion where the mounting part contacts the head of the user or in the vicinity of this portion.

4. The head-mounted display according to claim 1, wherein a power switch that does not concern the operation of the video images is installed on the side of the headphone to which the display arm is attached.

5. The head-mounted display according to claim 2, wherein a power switch that does not concern the operation of the video images is installed on the side of the headphone to which the display arm is attached.

6. The head-mounted display according to claim 3, wherein a power switch that does not concern the operation of the video images is installed on the side of the headphone to which the display arm is attached.
